(19) United States
(12) Patent Application Publication
(10) Pub. No.: US 2019/0161406 A1
(43) Pub. Date: May 30, 2019

(54) FLUXANT AGENTS FOR HYDROCARBON BINDERS

(71) Applicants: RHODIA OPERATIONS, PARIS (FR); EUROVIA, RUEIL MALMAISON (FR)

(72) Inventors: Arnaud BOURDETTE, CHELLES (FR); Frédéric DELFOSSE, PESSAC (FR); Marie-Pierre LABEAU, SEVRES (FR); Thomas LEBARBÉ, AUDENGE (FR); Hélène MARTIN, CHATILLON (FR); Simon ROUSSEAU, TALENCE (FR); Marie-Laure PIERRE, VILLENAVE D'ORNON (FR)

(73) Assignees: RHODIA OPERATIONS, PARIS (FR); EUROVIA, RUEIL MALMAISON (FR)

(21) Appl. No.: 16/320,720

(22) PCT Filed: Jul. 26, 2017
(86) PCT No.: PCT/FR2017/052082

§ 371 Date: Jan. 25, 2019

(30) Foreign Application Priority Data
Jul. 26, 2016 (FR) 1657180
Apr. 27, 2017 (FR) 1753676

(51) Int. Cl. C04B 24/04; C04B 26/26

(52) U.S. Cl. CPC C04B 24/04; C04B 2103/0093; C04B 26/26

(57) ABSTRACT

The invention concerns the use as a fluxant agent of at least one compound with the formula (I)

R¹—X—R—Y—R² (I)
where:
R¹ and R², which can be identical or different, are hydrocarbon chains, linear or branched, at C₂-C₁₁;
each of —X— and —Y—, which can be identical or different, is an —O—(C═O)— group; —(C═O)—O—; —NR′—(C═O)—, where R′ represents a hydrocarbon atom or an alkyl radical at C₁-C₄, or —(C═O)—NR′—, where R′ represents a hydrocarbon atom or an alkyl radical at C₁-C₄,
the —R— group is a divalent hydrocarbon chain, at C₁-C₁₀, linear or branched, and possibly interrupted by one or more oxygen atom(s)
   in a composition including a hydrocarbon binder for the preparation of the bituminous product based on solid mineral particles in contact with the said hydrocarbon binder, where the said compound of formula (I) is present in the said composition when the said composition is brought into contact with the said solid mineral particles.

The present invention relates to the field of fluxant agents for hydrocarbon binders, which can be used in particular in road construction applications. More specifically, the invention concerns the use as a fluxant agent of a specific volatile compound of formula (I) as defined below in a composition including a hydrocarbon binder used to produce a bituminous product based on mineral particles bound together by the said composition including the hydrocarbon binder.

In “bituminous” products, mineral particles are bound by a hydrocarbon binder, in particular a bitumen. The hydrocarbon binders which are used in bituminous products of this type are very viscous products, typically viscoelastic, which to be handled must be heated, emulsified and/or have additives added in the form of compounds called “fluxant” compounds, one effect of which is to enable their viscosity to be reduced. These fluxants can be of petroleum, petrochemical, carbochemical or plant origin.

Habitual fluxants are the fluxants of petroleum origin which include:
“petroleum fluxants”, which are products derived from the distillation of crude oil (light fraction(s)), which may have been subjected to a hydrotreating operation. One can cite as examples the fluxant agents sold by Total (Greenflux® 2000, Greenflux® SD in particular).
“petrochemical fluxants”, which are products derived from the distillation of crude oil (light fraction(s)), having been subject to at least one thermal cracking operation and additional distillation. One can cite as an example the fluxant agents sold by VFT France (Adheflux®).

Such fluxants of petroleum origin are very satisfactory in terms of results. Indeed, when they are added to a hydrocarbon binder they enable its viscosity to be reduced from time to time, whilst ensuring generally that the mechanical properties of the bituminous product based on this fluxed hydrocarbon binder are not significantly impaired, and thus make them fit for their use for roads, in particular with a sufficient cohesion increase.

These fluxants of petroleum origin are volatile products: after they are incorporated in the hydrocarbon binder where they reduce the viscosity as desired they evaporate, causing the binder to recover its original characteristics appreciably. However these released fluxants have many negative environmental impacts. In addition, their use is dangerous and uncomfortable (harmful and unpleasant vapours, and danger of flammability).

Other volatile fluxant agents are the fluxants of carbochemical origin, which are products derived from pyrolysis of carbon, after being subject to at least one distillation operation, which have the major disadvantage that they are recognised carcinogens.

To replace the above-mentioned volatile fluxants, fluxants have been proposed of natural, non-fossil origin (plant or animal origin), which enable the release of harmful volatile organic compounds to be avoided. A fluxant of non-fossil natural origin is a non-fossil natural oil, one of its derivatives such as the esters of fatty acid, or a blend of two or more of these oils and/or oil derivatives. One can cite in particular the plant oils such as the oils of sunflower, rapeseed, groundnut, copra, flax, palm, soya, olive, castor, corn, marrow, grape pips, jojoba, sesame, walnut, hazelnut, tung oil, tall oil, their derivatives, and blends of them. Most of these oils consist essentially of fatty acids at least with unsaturated C₁₆. Such fluxants are, for example, described in applications FR 2 910 477, EP 0 900 822, FR 2 721 043 or FR 2 891 838.

With non-volatile fluxants of the type of the above-mentioned oils, the increase in consistency of the binder in the final product (after spreading or after coating) is not accomplished by evaporation, unlike with volatile fluxants, but rather by cross-linking, typically after radical reactions, with the unsaturated fatty chains reacting in the presence of airborne oxygen. These reactions, which can be catalysed by the addition of drying agents such as metal salts, include the formation of —O—O— peroxide bridges on the unsaturated chains. These bridges are unstable and lead to the formation of free radicals, which will themselves react with other unsaturations of other chains. This technique of cross-linking of the fluxant thus applies only to unsaturated compounds. The fluxant is selected on the basis of the iodine index which characterises the rate of unsaturations of a compound, and therefore its ability to react by siccativation.

Although they have lesser effects on the environment and the well-being and health of those handling them, fluxants of non-fossil natural origin are, however, less satisfactory than fluxants of petroleum origin in terms of results. Indeed, the results in terms of cohesion increase are less satisfactory. They usually lead to disorders in the case of showers, heat or excessively dense traffic, problems of bleeding, related in particular to poor adhesion of the fluxed hydrocarbon binder to the solid mineral particles.

Bituminous products based on bitumen fluxed with fluxants of non-fossil natural origin are thus currently considered to be not suitable for moderate to dense traffic with climatic variations.

One aim of the invention is to provide a solution:
enabling the viscosity of a hydrocarbon binder to be reduced
enabling a hydrocarbon binder of wettability which is suitable with regard to solid mineral particles to be obtained
without having the above-mentioned disadvantages

To this end, it is proposed according to the present invention to use, as fluxants, specific compounds, concerning which the inventors have now discovered, in the course of the work which led to the present invention, (1) that they behave as interesting volatile fluxants which, after being incorporated in compositions including a hydrocarbon binder, and before their evaporation, enable the viscosity of the hydrocarbon binder to be reduced, which can consequently be used more easily, but without having the disadvantages of habitual volatile fluxants, in terms of impact on the environment and toxicity for their handler; and (2) that they also lead for the composition to a satisfactory wettability with regard to solid mineral particles, of the same order as the wettabilities of the best fluxant agents currently used, such as Greenflux® SD, which in particular allows satisfactory adherence to the solid mineral particles.

Another object of the invention is the use, as a fluxant agent, of at least one compound with the formula (I)

R¹—X—R—Y—R² (I)
where:
R¹ and R², which can be identical or different, are hydrocarbon chains, linear or branched, at C₂-C₁₁;
each of —X— and —Y—, which can be identical or different, is an —O—(C═O)— group;
—(C═O)—O—; —NR′—(C═O)—, where R′ represents a hydrocarbon atom or an alkyl radical at C₁-C₄, or (C═O)—NR′—, where R′ represents a hydrocarbon atom or an alkyl radical at C₁-C₄,
the —R— group is a divalent hydrocarbon chain, at C₁-C₁₀, linear or branched, and possibly interrupted by one or more oxygen atom(s)
   in a composition including a hydrocarbon binder for the preparation of a bituminous product based on solid mineral particles in contact with the said hydrocarbon binder, where the said compound of formula (I) is present in the said composition when the said composition is brought into contact with the said solid mineral particles.

According to the invention, it is possible to use a single compound of formula (I) or alternatively a blend of several compounds of formula (I).

Compounds of formula (I), alone or in blends, prove to be compounds concerning which the work of the inventors has shown that they are volatile within a hydrocarbon binder of the bitumen type, and that they therefore produce an effect similar to fluxants of petroleum origin, but without the problems of their environmental impact and of toxicity for the handler.

In addition, compounds of formula (I), before being volatilised, produce not only a one-off reduction of the viscosity of the binder, but in addition a wettability of the solid mineral particles by the binder of the same order as that of the best fluxant agents currently in use.

The compound of formula (I) as it is used according to the invention is not used only to reduce the viscosity of the hydrocarbon binder but also, more specifically, to produce a satisfactory wettability of the solid mineral particles by the composition including the binder. To this end, the compound of formula (I) is present in the bituminous composition for the whole or a part of the period of time during which the composition is brought into contact with the solid mineral particles. In practice the compound of formula (I) can in particular be added to the composition including the hydrocarbon binder according to one and/or other of the following 3 compatible variants:
variant 1: the compound of formula (I) is added at least partly (if variant 2 and/or 3 is also used), or wholly (otherwise), to the composition including the hydrocarbon binder; the composition including the compound of formula (I) is then brought into contact with the solid mineral particles before complete evaporation of the compound of formula (I) outside the composition (in other words the said compound of formula (I) is still present, at least in part, in the composition when it is brought into contact with the solid mineral particles, preferably in a sufficient quantity in the composition for it to act as a fluxant);
and/or
variant 2: the compound of formula (I) is added at least in part (if variant 1 and/or 3 is also used), or wholly (otherwise), at the same time as the solid mineral particles, to the composition including the hydrocarbon binder
and/or
variant 3: the compound of formula (I) is added at least in part (if variant 1 and/or 2 is also used), or wholly (otherwise), to a pre-blend containing the solid mineral particles, and the composition including the hydrocarbon binder

It should be noted that when variant 2 and/or 3 is used it can certainly be envisaged to use, in a prior step (E0), compounds of formula (I) as fluxants in the binder-based composition (for example to manufacture a composition of the bitumen emulsion type), and then to leave the compounds of formula (I) used to evaporate completely. In this case, to implement variant 2 or 3, compounds of formula (I), identical or different to those used in the prior step (E0), will be introduced jointly and/or after the composition is blended with the solid mineral particles.

The compounds of formula (I) according to the invention enable the viscosity of the hydrocarbon binder to which they are added to be reduced, whilst guaranteeing satisfactory wettability of the solid mineral particles by the composition including the binder.

Advantageously, the compounds of formula (I) according to the invention also enable a binder to be obtained which is effective after stabilisation (this effectiveness can be ascertained by means of penetrability results, ring and ball temperature results, and possibly Fraass brittle point results)

Compounds of formula (I) according to the invention preferably enable a reduction of the viscosity of the hydrocarbon binder when it is used, without affecting its properties and its ability to wet the solid mineral particles.

In one variant of the invention the composition also includes a compound satisfying formula (II)

R¹—X—R—Y—R² (II)
where:
R¹ and R², which can be identical or different, are hydrocarbon chains, linear or branched, at C₁-C₁₁, and preferably at C₁-C₉; and where at least one of R¹, R² is a methyl radical
—X— and —Y—, —R— are as defined for formula (I).

According to the invention, it is possible to use a single compound of formula (II) or alternatively a blend of several compounds of formula (II).

The compounds of formula (II), alone or as part of blends, prove to be compounds concerning which the inventors' work has shown that they are volatile within a hydrocarbon binder of the bitumen type.

This compound of formula (II) will advantageously be able to be introduced in a blend with the compound of formula (I), according to one and/or other of the above-mentioned variants 1, 2 and/or 3 or during step (E0). More generally, a fluxant agent and/or one or more compounds of formula (II) will be able to be added to the composition before and/or during and/or after (and preferably before and/or during) the solid mineral particles are brought into contact with the composition, regardless of when the compound of formula (I) is introduced. According to one particular implementation, at least a proportion of the compounds of formula (I) and at least a proportion of the compounds of formula (II) are present simultaneously in the composition, preferably at least during a part of the time when the composition is in contact with the solid mineral particles.

The ratio of the content by weight of composition of formula (I) to content of compound of formula (II) is advantageously higher than or equal to 1, more advantageously between 1 and 5, and even more advantageously between 1 and 3.

The definitions below will be adopted throughout the present description:

Hydrocarbon Binder:

The term “hydrocarbon binder” is understood to mean any hydrocarbon binder of fossil or plant origin which can be used for the production of “bituminous” products, where this hydrocarbon binder typically may or may not be bitumen, and be pure or modified, in particular through the addition of polymer(s).

The binder will be able to be a soft to hard binder, advantageously of a grade ranging from 10/20 to 160/220.

The hydrocarbon binder can be a bitumen, whether pure or modified by polymers.

The “polymer” modifying the bitumen to which reference is made here can be chosen from among the natural or synthetic polymers. This relates, for example, to a polymer of the family of elastomers, whether synthetic or natural, and, indicatively and non-restrictively:
the statistical copolymers, whether multi-sequence or star, of styrene and of butadiene or of isoprene in all proportions (in particular block copolymers of styrene-butadiene-styrene (SBS), styrene-butadiene (SB, SBR for styrene-butadiene rubber), of styrene-isoprene-styrene (SIS)) or the copolymers of the same chemical family (isoprene, natural rubber, etc.), possibly cross-linked in situ,
the copolymers of vinyl and ethylene acetate, in all proportions,
   the copolymers of ethylene and of esters of acrylic or methacrylic acid or of maleic anhydride, the copolymers and terpolymers of ethylene and of glycidyl methacrylate) and polyolefins.

The polymer modifying the bitumen can be chosen from among recovered polymers, for example “fine rubber powders”, or other rubber-based compositions reduced into pieces or powder, for example obtained from worn tyres or other polymer-based waste (wires, packaging, agricultural waste, etc.) or alternatively all other polymers commonly used to modify bitumens, such as those cited in the Technical Guide written by the International Road Association (AIPCR) and published by Laboratoire Central des Ponts et Chaussées [Central Bridges and Roads Laboratory] “Use of Modified Bituminous Binders, Special Bitumens and Bitumens with Additives in Road Pavements” (Paris, LCPC, 1999), together with all blends in all proportions of these polymers.

The composition including the binder can be in the form of an anhydrous binder or in the form of an emulsion (typically a bitumen emulsion).

The emulsion is a dispersion of the binder (bitumen, synthetic binder or plant binder) in a continuous phase, typically in an aqueous phase, for example water. A surfactant agent can be added to the emulsion, which in particular enables it to be stabilised.

During the manufacture of an emulsion the binder is dispersed in fine droplets in the water, for example by a mechanical action. Adding a surfactant agent forms a protective film around the droplets, preventing them from coagulating, and thus enabling the blend to be kept stable, and enabling it to be stored for a certain period. The quantity and type of surfactant agent added to the blend determine the stability of the emulsion when stored, and influence the curing time when it is laid. The surfactant agent can be positively charged, negatively charged, amphoteric or non-ionic.

The surfactant agent is advantageously of petroleum, plant or animal origin, and blends of them (for example, the surfactant agent can be of plant and petroleum origin). The surfactant agent can be an alkaline soap of fatty acids: sodium or potassium salts of an organic acid (for example resin). The emulsion is then anionic. The surfactant agent can be an acidic soap, which is generally obtained by action of hydrochloric acid on one or two amines. The emulsion is then cationic. Among the surfactants which are effective for road construction applications one can cite: the surfactants sold by Akzo NOBEL (Redicote® E9, Redicote® EM 44, Redicote® EM 76), the surfactants sold by CECA (Dinoram® S, Polyram® S, Polyram® L 80) and the surfactants sold by Meadwestvaco (Indulin® R33, Indulin® R66, Indulin® W5). One or more of these surfactants can be used, alone or in blends.

The emulsion can contain synthetic or natural latex. The term “latex” is understood to mean a dispersion of polymer (polyisoprene, SBS, SB, SBR, acrylic polymers, etc.) whether or not cross-linked, in aqueous phase. This latex is incorporated in the aqueous phase before emulsification or in the production line during manufacture of the emulsion, or alternatively after the emulsion has been manufactured.

The composition including the binder can take the form, wholly or partly, of a foam typically obtained using a process of injecting a quantity of water, and possibly air, in the binder inlet, where the water is pure or or can include additives enabling the adhesive force or rheological properties of the binder to be modified.

Whatever its form, the composition including the binder, typically within the binder, additives commonly used in the road construction field, such as compositions based on powdered rubber (“fine rubber powders”), plant waxes or waxes of petrochemical origin, adhesion agents.

Solid Mineral Particles

The term “solid mineral particles” is understood to mean, in the present description, all solid particles which can be used to produce bituminous products, in particular for road construction, including in particular natural mineral aggregates (chippings, sand, fines) derived from quarries or gravel pits, recycling products such as asphalt mix aggregates resulting from the recycling of materials recovered when roads are repaired, together with surpluses of coating plants, manufacturing scrap, “shingles” (derived from the recycling of roof membranes), aggregates derived from the recycling of road materials including concretes, slags, in particular scoria, schists, in particular bauxite or corumdum, fine rubber powders derived from the recycling of tyres in particular, artificial aggregates of all origins, derived for example from clinkers from the incineration of household waste (MIOM), together with their blends in all proportions.

Natural mineral aggregates include:
elements smaller than 0.063 mm (filler or fines)
sand, the grains of which are between 0.063 mm and 2 mm in size;
chippings
   of between 2 mm and 6 mm in size;
   larger than 6 mm;

The size of the mineral aggregates is measured by the tests described in standard NF EN 933-2 (version of May 1996).

The term “asphalt mix aggregates” is understood to mean asphalt mixes (blend of aggregates and bituminous binders) derived from milling of layers of asphalt mix, crushing of plates extracted from highways made from asphalt mixes, pieces of plates of asphalt mixes, asphalt mix waste or surpluses from production of asphalt mixes (production surpluses are materials which are coated or partially coated in the plant produced in the transitional manufacturing phases). The size of these elements and the other recycling products can be as as large as 31.5 mm.

The “solid mineral particles” are also designated by the terms “0/D mineral fraction”. This 0/D mineral fraction can be separated into two granulometries: the 0/d mineral fraction and the d/D mineral fraction.

The finest elements (the 0/d mineral fraction) will be those within the range 0 to a maximum diameter which can be set at between 2 and 6 mm (0/2 to 0/6), and advantageously between 2 and 4 mm. The other elements (minimum diameter greater than 2, 3, 4, 5 or 6 mm; and approximately as high as 31.5 mm) constitute the d/D mineral fraction.

Compound of Formula (I)

In the invention a compound, or blend of compounds, is used which satisfies formula (I)

R¹—X—R—Y—R² (I)
where:
R¹ and R², which can be identical or different, are hydrocarbon chains, linear or branched, at C₂-C₁₁, and preferably at C₂-C₉;
each of —X— and —Y—, which can be identical or different, is an —O—(C═O)— group; —(C═O)—O—; —NR′—(C═O)—, where R′ represents a hydrocarbon atom or an alkyl radical at C₁-C₄, or (C═O)—NR′—, where R′ represents a hydrocarbon atom or an alkyl radical at C₁-C₄,
the —R— group is a divalent hydrocarbon chain, at C₁-C₁₀, linear or branched, and possibly interrupted by one or more oxygen atom(s)

It should be noted that, according to a variant of the invention, the compound of formula (I) may take the form of a blend comprising various compounds of formula (I). In the application, unless there is an explicit mention of the presence of at least two compounds, “one” compound can designate a single compound satisfying formula (I) or a blend or an association of several compounds satisfying formula (I).

In the compounds of formula (I) used according to the invention, the total number of carbon atoms is preferably between 7 and 16. According to one implementation the total number of carbon atoms is higher than or equal to 8, or higher than or equal to 9. According to one implementation, the total number of carbon atoms is 8, 9 or 10. According to one particular implementation, the number of carbon atoms is greater than or equal to 10, for example 11, and in particular greater than or equal to 12. In addition, it is generally preferred that the total number of carbon atoms is fewer than or equal to 15, for example fewer than or equal to 14. Thus, for example, the total number of carbon atoms can be between 8 and 15, for example between 8 and 12 or between 10 and 15 or between 10 and 12 or between 12 and 14.

The total number of carbon atoms defined in the previous paragraph is valid in particular when groups R, R¹ and R² are saturated groups, linear or branched, and in particular when these are saturated and branched groups.

When compounds of formula (I) have linear chains, groups R¹ and R² are typically saturated groups, generally identical, and containing 2 to 5 carbon atoms, and advantageously 2, 3 or 4 carbon atoms. In this case, saturated group R generally contains 1 to 8 carbon atoms, for example between 2 and 7, in particular between 2 and 6, with a total number of carbon atoms in the compound of formula (I) which can be between 8 and 16, in particular between 10 and 16, for example between 8 and 12 or between 10 and 12 or between 12 and 14.

Compounds of formula (I) also have a molecular mass of between 170 g/mole and 280 g/mole, more advantageously of between 180 g/mole and 280 g/mole, more advantageously of between 190 g/mole and 275 g/mole, even more advantageously of between 200 g/mole and 265 g/mole or more advantageously of between 170 g/mole and 275 g/mole, and even more advantageously of between 170 g/mole and 265 g/mole.

Compounds of formula (I) prove to be volatile in most hydrocarbon binders, and in particular in bitumen, meaning that over time they will evaporate from the bituminous compositions containing them, thus allowing cohesion increase of the bituminous products based on the said bituminous compositions.

R′ advantageously represents a hydrogen atom or a methyl group or an ethyl group.

Groups R¹ and R², which can be identical or different, advantageously represent an alkyl, aryl, alkyaryl or arylalkyl group, linear or branched, whether or not cyclic, whether saturated or unsaturated, and usually saturated, at C₂-C₁₁, and typically at C₂-C₉.

Groups R¹ and R², which can be identical or different, can in particular be chosen from among the ethyl, n-propyl, isopropyl, benzyl, phenyl, n-butyl, isobutyl, n-pentyl, isoamyl, cyclohexyl, hexyl, n-hexyl, heptyl, isooctyl, 2-ethylhexyl or 2-propylhexyl groups.

R¹ and R² each advantageously contains 2 to 5 carbon atoms, for example 2 carbon atoms or 3 to 5 carbon atoms. Typically (in particular for reasons of ease of synthesis) R¹ and R² are identical and are chosen from among the ethyl, n-propyl, isopropyl, n-butyl, isobutyl, n-pentyl or isoamyl groups, and in particular from among the ethyl or isobutyl groups.

The R group advantageously represents an alkanediyl radical at C₁-C₁₀, linear or branched, an alkenediyl radical at C₂-C₁₀, linear or branched, or indeed an alkoxylated chain, in particular an ethoxylated and/or propoxylated chain, at C₂-C₁₀.

One can use as compounds of formula (I) compounds in which R is as defined in one of the following implementations, or a blend of compound(s) according to these implementations:
Implementation 1: R is a radical of formula —(CH₂)ᵣ—, where r is an average number of between 2 and 8 inclusive. In particular, R is a radical of formula —(CH₂)ᵣ—, where r is an average number of between 2 and 4 inclusive.

R is preferably chosen such that the compound can be a blend of adipate derivative (r=4), glutarate derivative (r=3), and succinate derivative (r=2).
Implementation 2: R is a branched alkanediyl radical at C₃-C₁₀. R can in particular be a group at C₃, C₄, C₅, C₆, C₇, C₈, C₉, or a blend. This is preferably a group at C₄.

Group R is preferably chosen from among the following groups:
the R_{MG} group of formula —CH(CH₃)—CH₂—CH₂—,
the R_{ES} group of formula —CH(C₂H₅)—CH₂—, and
their blends.

Such blends, together with appropriate methods for obtaining them, are described in particular in documents WO 2007/101929; WO 2007/141404; WO 2008/009792; WO 2008/062058.
Implementation 3: R is an alkenediyl radical, linear or branched, at C₂-C₈, and advantageously at C₂-C₄.

Group R is preferably chosen from among the following groups:
the group of formula —CH═CH—, the double link being of configuration Z
the group of formula —CH═CH—, the double link being of configuration E
the group of formula —CH(CH₂)—CH₂—, and
their blends.
Implementation 4: R is a radical -(OE/OP)ₙ- where OE/OP are alkoxy groups, preferably chosen from among the ethoxy and propoxy groups and the ethoxy/propoxy blends, and n is an average number of between 1 and 5 inclusive, and with a total number of carbon atoms of 10 in group R.

In particular in the above-mentioned implementations 1 to 4, X and Y are advantageously esters, and preferably esters of diacids (—X—=—O—(C═O)—; and Y=—(C═O)—O—) or esters of diols (—X—=—(C═O)—O— and Y=—O—(C═O)—)

### Advantageously,

R¹ and R² are identical or different, and are each chosen from among the ethyl, n-propyl, isopropyl, n-butyl, isobutyl, n-pentyl, isoamyl, hexyl, n-hexyl, isooctyl, 2-ethylhexyl and 2-propylhexyl groups; in particular ethyl or isobutyl;
X and Y are advantageously esters, and preferably esters of diacids (—X—=—O—(C═O)—; and —Y—=—(C═O)—O—) or esters of diols (—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), diesters of glutarate (r=3), and diesters of succinate (r=2).

In one implementation of the invention the compound (I) used in the present invention is chosen from among diisobutyl adipate, diisobutyl glutarate or diisobutyl succinate, and their blends.

A suitable blend can, for example, include, by weight in relation to the total weight of the blend, a blend of 5 to 29% by weight of diisobutyl adipate (typically measured by Gas Phase Chromatography), 50 to 72% by weight of diisobutyl glutarate, and 10 to 32% by weight of diisobutyl succinate.

The solvent sold by Solvay named Rhodiasolv® DIB can be used as compound (I).

In another implementation of the invention compound (I) used in the present invention is chosen from among diethyl adipate, diethyl glutarate or diethyl succinate, and their blends.

A suitable blend can, for example, include, by weight relative to the total weight of the blend, a blend of 4 to 26% by weight of diethyl adipate (typically measured by Gas Phase Chromatography), 52 to 77% by weight of diethyl glutarate, and 12 to 32% by weight of diethyl succinate.

The solvent sold by Solvay named INNROAD® Protect can be used as compound (I).

In yet another particular implementation of the invention compound (I) used in the present invention is chosen from among diisopropyl adipate, diisopropyl glutarate or diisopropyl succinate, and their blends.

A suitable blend, used in the examples and designated in the present description by “DIP”, includes, by weight relative to the total weight of the blend, a blend of 5 to 29% by weight of diisopropyl adipate (typically measured by Gas Phase Chromatography), 50 to 72% by weight of diisopropyl glutarate, and 10 to 32% by weight of diisopropyl succinate.

In yet another possible implementation compound (I) used in the present invention is chosen from among diisoamyl adipate, diisoamyl glutarate or diisoamyl succinate, and their blends.

A suitable blend, used in the examples and designated in the present description by “DIA”, includes, by weight relative to the total weight of the blend, a blend of 5 to 29% by weight of diisoamyl adipate (typically measured by Gas Phase Chromatography), 50 to 72% by weight of diisoamyl glutarate, and 10 to 32% by weight of diisoamyl succinate.

A Compound of Formula (II)

A compound satisfying formula (II) can be used in the invention

R¹—X—R—Y—R² (II)
where:
R¹ and R², which can be identical or different, are hydrocarbon chains, linear or branched, at C₁-C₁₂, and preferably at C₁-C₁₀; and where at least one of R¹, R² is a methyl radical
—X— and —Y—, —R— are as defined for formula (I).

It should be noted that according to a variant of the invention the compound of formula (II) can take the form of a blend of various compounds of formula (II). In the application, unless there is an explicit mention of the presence of two compounds, “one” compound can refer to a single compound satisfying formula (II) or a blend of an association of several compounds satisfying formula (II).

Compounds of formula (II) advantageously have a molecular mass of between 130 g/mole and 290 g/mole, more advantageously of between 140 g/mole and 250 g/mole, and yet more advantageously of between 150 g/mole and 200 g/mole.

In compounds of formula (II) used according to the invention, the total number of carbon atoms is preferably between 5 and 12. According to one implementation the total number of carbon atoms is higher than or equal to 6. In addition, it is generally preferred that the total number of carbon atoms is fewer than or equal to 11, for example fewer than or equal to 10. Thus, for example, the total number of carbon atoms can be between 6 and 11, for example between 6 and 8.

The total number of carbon atoms defined in the previous paragraph is valid in particular when groups R, R¹ and R² are saturated groups, linear or branched,
—X— and —Y—, —R— are as defined for formula (I), including the various variants.

Groups R¹ and R², which can be identical or different, advantageously represent an alkyl, aryl, alkyaryl or arylalkyl group, linear or branched, whether or not cyclic, whether saturated or unsaturated, and usually saturated, at C₁-C₁, and typically at C₁-C₉. At least one of R¹, R² is a methyl radical.

Groups R¹ and R², which can be identical or different, can in particular be chosen from among the methyl, ethyl, n-propyl, isopropyl, benzyl, phenyl, n-butyl, isobutyl, n-pentyl, isoamyl, cyclohexyl, hexyl, n-hexyl, heptyl, isooctyl, 2-ethylhexyl, or 2-propylhexyl groups. At least one of R¹, R² is a methyl radical.

Advantageously, R¹, R² both represent a methyl radical.

A compound of formula (II) according to the invention can, for example, be chosen from among dimethyl adipate, dimethyl glutarate, dimethyl succinate, and their blends.

A suitable blend can, for example, include, by weight relative to the total weight of the blend, a blend of dimethyl adipate (for example 4 to 22% by weight, by Gas Phase Chromatography), dimethyl glutarate (for example 55 to 77% by weight), and dimethyl succinate (for example 12 to 32% by weight).

The solvent sold by Solvay named Rhodiasolv® RPDE or the solvent sold by Solvay named INNROAD®Boost can be used as compound (II).

Another possible compound of formula (II), which can be used alone or in a blend with the previous one, is a compound for which R¹, R² both represent a methyl radical and group R is chosen from among the following groups:
the R_{MG} group of formula —CH(CH₃)—CH₂—CH₂—,
the R_{ES} group of formula —CH(C₂H₅)—CH₂—, and
their blends.
—X— and —Y— are advantageously esters, preferably esters of diacids
   (—X—=—O—(C═O)—; and —Y—=—(C═O)—O—) or esters of diols (—X—=—(C═O)—O— and —Y—=—O—(C═O)—).

The solvent sold by Solvay named Rhodiasolv® IRIS can be used as compound (II).

Bituminous Products

The term “bituminous product”, in the present invention, is understood to mean a product based on a hydrocarbon binder and solid mineral particles. One can in particular cite dressings, emulsion asphalt mixes, storable asphalt mixes, hot mixes, and warm mixes with controlled workability which are described in greater detail below.

Bituminous products can contain high volumes (ranging from 0% to 100% by weight, advantageously from 20% to 50% by weight, relative to the total weight) of recycling products (aggregates of asphalt product, asphalt mix aggregates).

Dressings

A surface dressing, within the meaning of the present description, refers to a layer consisting of superposed layers of a hydrocarbon binder and of solid mineral particles. It is typically obtained by spraying a hydrocarbon binder and then by spreading solid mineral particles on this binder, in one or more layers. The product is then compacted. A surface dressing requires not only a binder which is sufficiently fluid to be able to be sprayed, but also a binder which enables satisfactory bonding of the solid mineral particles on to the support.

The fluxant added to the binder must thus enable it to be softened without impairing the wetting of the solid mineral particles by the binder. The fluxant must also enable the binder to be softened when it is being sprayed, but when it has been sprayed the binder must harden rapidly, in order also to meet the criterion of cohesion increase. If the binder does not correctly wet the solid mineral particles the adhesion of this binder on to these particles will not be satisfactory, or unacceptable.

The binder-solid mineral particles affinity is determined by the possibility of wetting of the solid mineral particles by the binder, which can be assessed by means of the test for determining the binders-aggregates adhesive force by measuring the Vialit cohesion (NF EN 12272-3, 2003 Jul. 1).

It has been discovered that compounds of formula (I) enable the binder to be fluxed effectively, with satisfactory cohesion increase, without impairing the binder-solid mineral particles affinity.

Compound(s) of formula (I) are advantageously added in their entirety to the composition including the hydrocarbon binder and then the composition including the hydrocarbon binder and the compound(s) of formula (I) is sprayed on the solid mineral particles before the compound of formula (I) evaporates completely out of the composition. In other words, the said compound of formula (I) is still present at least in part when the fluxed binder and the solid mineral particles are brought into contact, preferably in a sufficient quantity in the composition to allow satisfactory adhesion of the binder to the solid mineral particles.

In an implementation suitable for dressings, in formula (I)
R¹ and R² are identical, and each is chosen from among the ethyl, n-propyl, isopropyl, n-butyl, isobutyl, n-pentyl, isoamyl, hexyl, n-hexyl, isooctyl, 2-ethylhexyl or 2-propylhexyl groups, and in particular from the isobutyl group;
X and Y are advantageously esters, and preferably esters of diacids (—X—=—O—(C═O)—; and —Y—=—(C═O)—O—) or esters of diols (—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), of diesters of glutarate (r=3), and of diesters of succinate (r=2).

In an advantageous implementation of the invention, compound (I) used in a dressing is diisobutyl adipate, diisobutyl glutarate or diisobutyl succinate, and their blends.

A suitable blend can, for example, include, by weight in relation to the total weight of the blend, a blend of 5 to 29% by weight of diisobutyl adipate (typically measured by Gas Phase Chromatography), 50 to 72% by weight of diisobutyl glutarate, and 10 to 32% by weight of diisobutyl succinate.

The solvent sold by Solvay named Rhodiasolv® DIB can be used as compound (I).

In another advantageous implementation of the invention compound (I) used in the present invention is chosen from among diethyl adipate, diethyl glutarate or diethyl succinate, and their blends.

A suitable blend can, for example, include, by weight relative to the total weight of the blend, a blend of 4 to 26% by weight of diethyl adipate (typically measured by Gas Phase Chromatography), 52 to 77% by weight of diethyl glutarate, and 12 to 32% by weight of diethyl succinate.

The solvent sold by Solvay named INNROAD® Protect can be used as compound (I).

The solid mineral particles used in a dressing advantageously belong to the following granular classes (d/D): 4/6.3, 6.3/10, 10/14.

The total hydrocarbon binder content in a dressing will be modified depending on the structure of the dressing (single- or twin-layer, type of chippings), on the nature of the binder and on the dimension of the aggregates, following for example the recommendations of the document “Wear surface dressings —Technical Guide, May 1995”.

The hydrocarbon binder used for the manufacture of a dressing can be a pure bitumen or one modified by polymers, as described above.

The hydrocarbon binder used for the manufacture of a dressing can be in the form of an anhydrous binder, or in the form of an emulsion binder.

In one implementation the hydrocarbon binder is used in the form of an anhydrous binder when manufacturing the dressing.

In this implementation the hydrocarbon binder advantageously includes, relative to the total weight of the hydrocarbon binder, 3% to 18% by weight of the said compound of formula (I).

In this implementation the dressing is advantageously used at a temperature of less than or equal to 200° C., for example ranging from 120° C. to 180° C. or ranging from 130° C. to 160° C.

In another implementation the hydrocarbon binder is an emulsion binder.

In this implementation the hydrocarbon binder advantageously includes, relative to the total weight of the hydrocarbon binder, 0.1 to 10% by weight of the said compound of formula (I), more advantageously 0.5 to 8% by weight, and yet more advantageously 1 to 6% by weight.

In this implementation the dressing is advantageously used at a temperature of less than or equal to 40° C., for example ranging from 5° C. to 40° C. or ranging from 15° C. to 35° C.

Bituminous Concretes with Emulsion

Bituminous concretes with emulsion, also called emulsion asphalt mixes, are hydrocarbon asphalt mixes produced cold from aggregates and an emulsified hydrocarbon binder. The aggregates can be used without prior drying and heating, or be subject to partial, hot pre-coating. It can sometimes be necessary to heat the product after it is manufactured, when it is used.

This technique, called the “cold” technique, has in environmental terms the major advantage that it does not produce smoke emissions, which reduces the disturbance for workers and persons in the vicinity. Bituminous concretes with emulsion consist of a blend of solid mineral particles including aggregates, bitumen emulsion (whether or not modified), and additives.

However, the quality of the coating can be mediocre, and a phenomenon of ravelling can be seen: poor distribution of the bitumen film over the entire granular fraction, particularly if the fluxant or fluidifier content is high. The more fines the granular fraction contains the poorer the distribution of the binder will be over the granular fraction (mainly on the large elements).

To remedy or restrict these problems of loss of compactability and of poor distribution of the bitumen film over the entire granular fraction, the step of blending of the granular fractions and of the binder, and possibly of the fluxant agent, can be sequenced. These sequenced methods imply more steps, and are thus less economic.

It has now been discovered that compounds of formula (I) enable bituminous concretes with emulsion to be fluxed effectively. Compounds of formula (I) also assist with compacting. The invention can also enable the use of sequenced methods and/or heating to be avoided.

The compound(s) of formula (I) is/are advantageously added to the composition including the hydrocarbon binder according to one and/or other of the 3 variants described above on pages 4 and 5, and thus before and/or during and/or after the binder and the solid mineral particles are brought into contact. The compound(s) of formula (I) is/are introduced at the latest before the bituminous concrete with emulsion is used, and is/are present at least in part in the composition including the binder and the solid mineral particles to allow satisfactory adhesion.

In an implementation suitable for bituminous concretes, the compound(s) of formula (I) is/are introduced into the composition including the emulsion binder, and the said composition is then brought into contact with the solid mineral particles (variant 1).

In another implementation suitable for bituminous concretes, the compound(s) of formula (I) is/are introduced at least partly at the same time as the solid mineral particles into the composition including the hydrocarbon binder (variant 2).

In another implementation suitable for bituminous concretes, a proportion or all the compound(s) of formula (I) is/are introduced in a pre-blend based on emulsion binder and solid mineral particles (variant 3). The resulting composition still includes a sufficient quantity of compound of formula (I) for the bituminous concrete with emulsion to be used.

In yet another implementation suitable for bituminous concretes, in formula (I)
R¹ and R² are identical, and each is chosen from among the ethyl, n-propyl, isopropyl, n-butyl, isobutyl, n-pentyl, isoamyl, hexyl, n-hexyl, isooctyl, 2-ethylhexyl or 2-propylhexyl groups, and in particular from the isobutyl group;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), of diesters of glutarate (r=3), and of diesters of succinate (r=2).

Advantageously, compound (I) used for bituminous concretes with emulsion is diisobutyl adipate, diisobutyl glutarate or diisobutyl succinate, and their blends.

A suitable blend can, for example, include, by weight in relation to the total weight of the blend, a blend of 5 to 29% by weight of diisobutyl adipate (typically measured by Gas Phase Chromatography), 50 to 72% by weight of diisobutyl glutarate, and 10 to 32% by weight of diisobutyl succinate.

The solvent sold by Solvay named Rhodiasolv® DIB can be used as compound (I).

Compounds of formula (I), chosen in particular from among diethyl adipate, diethyl glutarate or diethyl succinate, and their blends, allow satisfactory compacting of the bituminous concrete with emulsion.

A suitable blend of compounds of formula (I) can, for example, include, by weight in relation to the total weight of the blend, a blend of 4 to 26% by weight of diethyl adipate (typically measured by Gas Phase Chromatography), 52 to 77% by weight of diethyl glutarate, and 12 to 32% by weight of diethyl succinate.

The solvent sold by Solvay named INNROAD® Protect can be used as compound (I).

Advantageously, for a bituminous concrete with emulsion, a compound of formula (II) of the above-mentioned type is also added.

In a first implementation suitable for bituminous concretes with emulsion, in formula (II):
R¹ and R² are identical and are each methyl;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), of diesters of glutarate (r=3), and of diesters of succinate (r=2).

Advantageously, compound (I) used for bituminous concretes with emulsion is dimethyl adipate, dimethyl glutarate or dimethyl succinate, and their blends.

A suitable blend can, for example, include, by weight in relation to the total weight of the blend, a blend of 4 to 22% by weight of dimethyl adipate (typically measured by Gas Phase Chromatography), 55 to 77% by weight of dimethyl glutarate, and 12 to 32% by weight of dimethyl succinate.

The solvent sold by Solvay named Rhodiasolv® RPDE or the solvent sold by Solvay named INNROAD®Boost can be used as compound (II).

In a second implementation suitable for bituminous concretes with emulsion, in formula (II):
R¹ and R² are identical and are each methyl;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is chosen from among the following groups:
   the R_{MG} group of formula —CH(CH₃)—CH₂—CH₂—,
   the R_{E}s group of formula —CH(C₂H₅)—CH₂—, and
   their blends.

In particular, the product sold by the company Solvay named Rhodiasolv® IRIS can be used as a compound of formula (II) for bituminous concretes with emulsion.

Solid mineral particles for bituminous concretes with emulsion advantageously include:
elements smaller than 0.063 mm (filler or fines)
sand, the grains of which are between 0.063 mm and 2 mm in size;
chippings between 2 mm and 6, 10 or 14 mm in size.

The hydrocarbon binder used for the synthesis of bituminous concretes with emulsion is in the form of emulsion binder. The total hydrocarbon binder content in the said emulsion is typically 2 to 8 pph (parts per hundred by weight), advantageously 3 to 7 pph, more advantageously 3.5 to 5.5 pph, relative to the weight of the solid mineral particles. This binder content is the quantity of binder introduced as such (contributed binder), plus the quantity of binder recovered from asphalt mix aggregates forming part of the solid mineral fraction.

The hydrocarbon binder in an emulsion used to manufacture a bituminous concrete with emulsion advantageously includes, relative to the total weight of hydrocarbon binder, 1 to 25% by weight of the said compound of formula (I), more advantageously 2 to 15% by weight, yet more advantageously 2 to 10% by weight, and yet more advantageously 3 to 10% by weight. These contents are calculated whether the compound of formula (I) is actually added to the binder before it is brought into contact with the solid mineral particles, or whether it is added to the composition including the binder and the solid mineral particles.

The hydrocarbon binder in an emulsion used for the manufacture of a bituminous concrete with emulsion can, possibly, include a compound of formula (II), advantageously 0.1 to 5% by weight of the said compound of formula (II), compared to the total weight of the hydrocarbon binder. These contents are calculated whether the compound of formula (II) is actually added to the binder before it is brought into contact with the solid mineral particles, or whether it is added to the composition including the binder and the solid mineral particles.

The bituminous concretes obtained according to the invention with emulsion can be used to manufacture storable asphalt mixes.

In this implementation the hydrocarbon binder advantageously includes, relative to the total weight of the hydrocarbon binder, 10 to 30% by weight of the said compound of formula (I), more advantageously 15 to 25% by weight, and yet more advantageously 17 to 22% by weight.

Cold Mix Bituminous Materials

Cold mix bituminous materials are surface course asphalt mixes consisting of undried aggregates coated with bitumen emulsion and poured in place continuously using a specific plant engine.

After the emulsion is used and broken a very thin layer of this cold mix coating (generally 6 to 13 mm thickness per layer) must reach its final consistency (cohesion increase) very rapidly. The two essential parameters governing the formulation, manufacture and use of cold mix bituminous materials are:
the workability of the aggregates/emulsion blend: optimisation of the proportions of the various constituents (water, additives, formulation of the emulsion) to obtain a sufficient period of use, and thus allow the aggregates to be blended with the emulsion in the mixer.
the kinetics of “cohesion increase”: after application on the highway the cold mix bituminous material must acquire cohesion increase as rapidly as possible for re-opening to traffic. For curing temperatures ranging from 7 to 40° C., a period of 30 minutes is considered as effective for those skilled in the art to meet the strictest specifications.

It has been discovered that compounds of formula (I) enable cold mix bituminous materials to be fluxed effectively. In particular, compounds of formula (I) enable the kinetics of cohesion increase of the cold mix bituminous material to be improved.

For a cold mix bituminous material the initially separated bitumen droplets give the system a fluid character and allow easy application using machines which are specific for cold mix bituminous materials. The system is then viscous. The characteristic period during which this state persists is called the workability period. In a subsequent period the bitumen droplets gradually coalesce. When all the bitumen droplets are grouped together it is considered that the emulsion has broken (breaking time). The system is then viscoelastic. The system subsequently tends to contract so as to reduce the contact surface between the water and the bitumen (cohesion period). This process adopts kinetics which will depend on the electrostatic repulsions between the droplets and therefore on the nature of the bitumen and the emulsifier. The kinetics of the coalescence reaction between the bitumen droplets will determine the speed of the cohesion increase of the cold mix bituminous material, which will be reflected by the material's sensitivity, or lack thereof, to the curing conditions when freshly poured Compounds of formula (I) advantageously enable the coalescence of the bitumen droplets to be facilitated.

In an implementation suitable for cold mix bituminous materials the compound(s) of formula (I) is/are introduced into the composition including the emulsion binder, and the said composition is then brought into contact with the solid mineral particles (variant 1).

In a first variant of the previous implementation, the compound(s) of formula (I) is/are introduced into the binder, and the binder is then emulsified in a continuous aqueous phase.

In a second variant of the previous implementation, the compound(s) of formula (I) is/are introduced into the already emulsified binder

In another implementation suitable for cold mix bituminous materials, the compound(s) of formula (I) is/are added at the same time as the solid mineral particles into the composition including the emulsified hydrocarbon binder (variant 2). It is possible to pre-blend the compounds of formula (I) and the solid mineral particles.

In another implementation the previous two implementations are combined, and thus:
a proportion of the compound(s) of formula (I) is introduced into the composition including the emulsion binder, according to the first or second variant, and the said composition is then brought into contact with solid mineral particles and
another proportion of the compound(s) of formula (I) is added at the same time as the solid mineral particles to the composition including the emulsified hydrocarbon binder and the previously introduced portion of the compounds of formula (I).

In another implementation suitable for cold mix bituminous materials, a proportion or all the compound(s) of formula (I) is/are introduced in a pre-blend based on emulsion binder and solid mineral particles (variant 3), before the emulsion breaks.

In an implementation suitable for cold mix bituminous materials, in formula (I)
R¹ and R² are identical, and each is chosen from among the ethyl, n-propyl, isopropyl, n-butyl, n-pentyl, isoamyl, isobutyl, hexyl, n-hexyl, isooctyl, 2-ethylhexyl or 2-propylhexyl groups, and in particular from the isobutyl group;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), of diesters of glutarate (r=3), and of diesters of succinate (r=2).

Advantageously, for cold mix bituminous materials, compound (I) used in the present invention is diisobutyl adipate, diisobutyl glutarate or diisobutyl succinate, and their blends.

A suitable blend can, for example, include, by weight in relation to the total weight of the blend, a blend of 5 to 29% by weight of diisobutyl adipate (typically measured by Gas Phase Chromatography), 50 to 72% by weight of diisobutyl glutarate, and 10 to 32% by weight of diisobutyl succinate.

The solvent sold by Solvay named Rhodiasolv® DIB can be used as compound (I).

It has been discovered, surprisingly, that the cohesion increase could be improved further when compound (I) used in the present invention is chosen from among diethyl adipate, diethyl glutarate or diethyl succinate, and their blends.

A suitable blend can, for example, include, by weight relative to the total weight of the blend, a blend of 4 to 26% by weight of diethyl adipate (typically measured by Gas Phase Chromatography), 52 to 77% by weight of diethyl glutarate, and 12 to 32% by weight of diethyl succinate.

The solvent sold by Solvay named INNROAD® Protect can be used as compound (I).

Advantageously, for a cold mix bituminous material, a compound of formula (II) is also added.

In a first implementation, in formula (II):
R¹ and R² are identical and are each methyl;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), diesters of glutarate (r=3), and diesters of succinate (r=2).

Advantageously, compound (II) used for cold mix bituminous materials is dimethyl adipate, dimethyl glutarate, dimethyl succinate, and their blends.

A suitable blend can, for example, include, by weight in relation to the total weight of the blend, a blend of 4 to 22% by weight of dimethyl adipate (typically measured by Gas Phase Chromatography), 55 to 77% by weight of dimethyl glutarate, and 12 to 32% by weight of dimethyl succinate.

The solvent sold by Solvay named Rhodiasolv® RPDE or the solvent sold by Solvay named INNROAD®Boost can be used as compound (II).

In a second implementation suitable for cold mix bituminous materials, in formula (II):
R¹ and R² are identical and are each methyl;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is chosen from among the following groups:
   the R_{M}G group of formula —CH(CH₃)—CH₂—CH₂—,
   the R_{ES} group of formula —CH(C₂H₅)—CH₂—, and
   their blends.

In particular, a compound of formula (II) suitable for cold mix bituminous materials is the product sold by Solvay named Rhodiasolv® IRIS.

The solid mineral particles used for cold mix bituminous materials advantageously include:
elements smaller than 0.063 mm (filler or fines)
sand, the grains of which are between 0.063 mm and 2 mm in size;
   chippings, the elements of which are between 2 mm and 6, 10 or 14 mm in size.

The hydrocarbon binder used for the manufacture of cold mix bituminous materials is in the form of an emulsion binder.

In this emulsion the binder content advantageously varies from 50 to 75% by weight of binder, relative to the total weight of the emulsion, more advantageously from 55 to 70% by weight, and yet more advantageously from 60 to 65% by weight.

The hydrocarbon binder suitable for cold mix bituminous materials advantageously includes, relative to the total weight of the hydrocarbon binder, 0.1 to 6% by weight of the said compound of formula (I), and more advantageously 0.1 to 3% by weight of the said compound of formula (I). In a variant, the hydrocarbon binder includes less than 2% by weight of the said compound of formula (I), advantageously less than 1.5% by weight, and yet more advantageously 0.1 to 1% by weight of the said compound of formula (I).

The hydrocarbon binder suitable for cold mix bituminous materials advantageously includes, relative to the total weight of the hydrocarbon binder, 0.1 to 3% by weight of the said compound of formula (II), and more advantageously 0.1 to 1% by weight of the said compound of formula (II).

Hot or Warm Mix Hydrocarbon Asphalt Mixes

Hot mix hydrocarbon asphalt mixes are obtained by hot mixing of the aggregates and of a binder. This binder can be a pure bitumen or a modified bitumen (for example, addition of polymer(s), fluxants of petroleum or plant origin), a pure or modified plant binder, or a synthetic binder of petroleum origin. The aggregates are heated, generally to a temperature of over 100° C.

Warm hydrocarbon asphalt mixes are asphalt mixes used at temperatures of approximately 30 to 50° C. below the temperatures used for hot mix hydrocarbon asphalt mixes.

It has been discovered that compounds of formula (I) enable hot or warm mix hydrocarbon asphalt mixes to be fluxed effectively, with a satisfactory cohesion increase, and satisfactory wettability of the solid mineral particles.

The compound(s) of formula (I) is/are advantageously added to the composition including the hydrocarbon binder according to one and/or other of the 3 variants described above on pages 4 and 5, and thus before and/or during and/or after the binder and the solid mineral particles are brought into contact. The compound(s) of formula (I) is/are introduced at the latest before the hot or warm mix hydrocarbon asphalt mixes are used, and is/are present at least in part in the composition including the binder and the solid mineral particles to allow satisfactory adhesion.

In a suitable implementation, the compound(s) of formula (I) is/are introduced in the composition including the binder, and the said composition is then brought into contact with solid mineral particles (variant 1).

In one implementation, suitable for hot or warm mix hydrocarbon asphalt mixes, in formula (I)
R¹ and R² are identical, and each is chosen from among the ethyl, n-propyl, isopropyl, n-butyl, isobutyl, n-pentyl, isoamyl, hexyl, n-hexyl, isooctyl, 2-ethylhexyl or 2-propylhexyl groups, and in particular from the isobutyl group;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), diesters of glutarate (r=3), and diesters of succinate (r=2).

Advantageously, compound (I) used in the present invention is diisobutyl adipate, diisobutyl glutarate or diisobutyl succinate, and their blends.

A suitable blend can, for example, include, by weight in relation to the total weight of the blend, a blend of 5 to 29% by weight of diisobutyl adipate (typically measured by Gas Phase Chromatography), 50 to 72% by weight of diisobutyl glutarate, and 10 to 32% by weight of diisobutyl succinate.

The solvent sold by Solvay named Rhodiasolv® DIB can be used as compound (I).

Advantageously, compound (I) used in the present invention is chosen from among diethyl adipate, diethyl glutarate or diethyl succinate, and their blends.

A suitable blend can, for example, include, by weight relative to the total weight of the blend, a blend of 4 to 26% by weight of diethyl adipate (typically measured by Gas Phase Chromatography), 52 to 77% by weight of diethyl glutarate, and 12 to 32% by weight of diethyl succinate.

the solvent sold by solvay named INNROAD® Protect can be used as compound (I).

Advantageously, for hot mix hydrocarbon asphalt mixes, a compound of formula (II) of the above-mentioned type is also added.

In a first implementation, suitable for hot mix hydrocarbon asphalt mixes, in formula (II):
R¹ and R² are identical and are each methyl;
X and Y are advantageously esters, and preferably esters of diacids (—X—=—O—(C═O)—; and —Y—=—(C═O)—O—) or esters of diols
(—X—=—(C═O)—O— and —Y—=—O—(C═O)—)
R is a radical of formula —(CH₂)ᵣ—, where r is an average number of between 2 and 4 inclusive. R is preferably chosen such that the compound can be a blend of diesters of adipate (r=4), diesters of glutarate (r=3), and diesters of succinate (r=2).

Advantageously, compound (II) used for cold mix bituminous materials is dimethyl adipate, dimethyl glutarate, dimethyl succinate, and their blends.

A suitable blend can, for example, include, by weight in relation to the total weight of the blend, a blend of 4 to 22% by weight of dimethyl adipate (typically measured by Gas Phase Chromatography), 55 to 77% by weight of dimethyl glutarate, and 12 to 32% by weight of dimethyl succinate.

The solvent sold by Solvay named Rhodiasolv® RPDE or the solvent sold by Solvay named INNROAD®Boost can be used as compound (II).

In a second implementation, suitable for hot mix hydrocarbon asphalt mixes, in formula (II):
R¹ and R² are identical and are each methyl;
X and Y are advantageously esters, and preferably esters of diacids (—X—=—O—(C═O)—; and —Y—=—(C═O)—O—) or esters of diols (—X—=—(C═O)—O— and —Y—=—O—(C═O)—)
R is chosen from among the following groups:
   the R_{MG} group of formula —CH(CH₃)—CH₂—CH₂—,
   the R_{ES} group of formula —CH(C₂H₅)—CH₂—, and
   their blends.

In particular, the product sold by the company Solvay named Rhodiasolv® IRIS can be used as a compound of formula (II) for hot mix hydrocarbon asphalt mixes.

The solid mineral particles are as defined above, and advantageously include:
elements smaller than 0.063 mm (filler or fines)
sand, the grains of which are between 0.063 mm and 2 mm in size;
   chippings, the elements of which are between 2 mm and 6, 10 or 14 mm in size.

The hydrocarbon binder is in the anhydrous form.

The total hydrocarbon binder content is 3 to 7 pph (parts per hundred by weight), more advantageously 3.5 to 6 pph, relative to the weight of the solid mineral particles.

This binder content is the quantity of binder introduced as such (contributed binder), plus the quantity of binder recovered from asphalt mix aggregates forming part of the solid mineral fraction.

In the case of hot or warm hydrocarbon asphalt mixes the hydrocarbon binder advantageously includes, relative to the total weight of the hydrocarbon binder, 1 to 30% by weight of the said compound of formula (I).

In the case of hot hydrocarbon asphalt mixes the hydrocarbon binder can also advantageously include, relative to the total weight of the hydrocarbon binder, 1 to 30% by weight of the said compound of formula (II).

The fluxant content is adjusted according to the period between manufacture and implementation.

When the hot or warm hydrocarbon asphalt mixes are used rapidly after manufacture, for example for the manufacture of surface courses, the hydrocarbon binder advantageously includes, relative to the total weight of the hydrocarbon binder, 0.1 to 6% by weight of the said compound of formula (I).

When the hot hydrocarbon asphalt mixes are used rapidly after manufacture, for example for the manufacture of surface courses, the hydrocarbon binder can also include, relative to the total weight of the hydrocarbon binder, 0.1 to 6% by weight of the said compound of formula (II).

These hot or warm hydrocarbon asphalt mixes can also be used for the manufacture of storable asphalt mixes.

In this implementation the hydrocarbon binder advantageously includes, relative to the total weight of the hydrocarbon binder, 15 to 30% by weight of the said compound of formula (I), more advantageously 15 to 25% by weight, and yet more advantageously 17 to 22% by weight.

In this implementation compound (I) is advantageously chosen from among diethyl adipate, diethyl glutarate or diethyl succinate, and their blends.

A suitable blend can, for example, include, by weight relative to the total weight of the blend, a blend of 4 to 26% by weight of diethyl adipate (typically measured by Gas Phase Chromatography), 52 to 77% by weight of diethyl glutarate, and 12 to 32% by weight of diethyl succinate.

The solvent sold by Solvay named INNROAD® Protect can be used as compound (I).

In the case of hot hydrocarbon asphalt mixes the hydrocarbon binder can also include, relative to the total weight of the hydrocarbon binder, 15 to 30% by weight of the said compound of formula (II), more advantageously 15 to 25% by weight, and yet more advantageously 17 to 22% by weight.

### EXAMPLES

### Description and Test Methods:

Stabilisation of fluxed binders:
   Anhydrous binders: This is a method for obtaining a thin binder layer. Stabilisation is accomplished according to standard NF EN 13074 1.2 (April 2011), leaving the fluxed bitumen for 24 h at laboratory temperature and then transferring it to a ventilated kiln for 24 h at 50° C., and finally for 24 h at 80° C. to enable evaporation of the fluxant.
   Emulsion binders: This is a method for obtaining a thin binder layer. Stabilisation is accomplished according to standard NF EN 13074 1.2 (April 2011), leaving the bitumen emulsion for 24 h at laboratory temperature and then transferring it to a ventilated kiln for 24 h at 50° C., and finally for 24 h at 80° C. to enable evaporation of the water and possibly of a fluxant.
STV pseudo-viscosity:
   Case of anhydrous binders: This is a method for measuring the viscosity of a fluxed bitumen by determination of the flow time of the product at 40° C. or 50° C. through an aperture measuring 10 mm. STV pseudo-viscosity is measured according to standard NF EN 12846-2 (April 2011).
   Case of emulsion binders: This is a method for measuring the viscosity of a bitumen emulsion by determination of the flow time of the product at 40° C. through an aperture measuring 2 and/or 4 mm. STV pseudo-viscosity is measured according to standard NF EN 12846-1 (April 2011).
Dynamic viscosity: TO BE COMPLETED
   Anhydrous binder: The dynamic viscosity of a fluxed bitumen is measured at approximately 140° C. (80° C. above the softening point) using a rotational viscosimeter NF EN 13302 (April 2010)
   Emulsion: The dynamic viscosity of a bitumen emulsion is measured at 40° C. using a rotational viscosimeter NF EN 13302 (April 2010)
Penetrability: Penetrability is the consistency expressed as the depth, in tenths of millimetres, corresponding to the vertical penetration of a reference needle in a test sample of the material, under prescribed conditions of temperature, load and period of application of the load. The penetrability test is conducted according to standard NF EN 1426 (June 2007). In the examples the measurements were made at 25° C., for a load of 100 g and a period of 5 s. Penetrability can be measured from a fluxed bitumen, a stabilised binder obtained from a fluxed bitumen, or alternatively from a stabilised binder obtained from a bitumen emulsion.
Ball-ring temperature: This is the temperature at which the binder reaches a precise consistency under the reference conditions of the test. Two horizontal discs of bitumen, moulded in brass shouldered rings, are heated in a liquid bath (water) stirred with a controlled rate of temperature rise (5° C./min., initial temperature of the bath of (5±1) ° C.), when each supports a steel ball. The noted softening point must be equal to the average of the temperatures at which both discs soften sufficiently to enable each ball, coated in bituminous binder, to descend by a height of (25.0±0.4) mm. The measurement is made according to standard NF EN 1427 (June 2007). The ball-ring temperature can be measured from a fluxed bitumen, a stabilised binder obtained from a fluxed bitumen, or alternatively from a stabilised binder obtained from a bitumen emulsion.
FRAASS brittle point: This test consists in measuring the temperature at which cracks appear in a film spread on a blade subjected to successive bending actions. The higher the FRAASS point the more fragile is the bitumen. The measurement is made according to standard NF EN 12593 (August 2015).
Mass loss after stabilisation: Mass loss after stabilisation is measured according to the mass difference between the binder deposited at the start of the stabilisation procedure and the mass of binder actually measured after the step of stabilisation (standard NF EN 13074 1.2, April 2011)
Evaporation curves (thermobalance): This is a measurement of the mass loss of a fluxed bitumen as a function of time at a fixed temperature of 85° C. The test is conducted using a thermobalance and enables the evaporation kinetics of a fluxant to be evaluated.
Adhesive force: This is a method for determining the binder-aggregates adhesive force and the influence of additives on the characteristics of this adhesive force (Standard NF EN 12272-3, July 2003). The quantity of binder required is heated to the spreading temperature, and then applied uniformly on a steel plate. The test is conducted at (5±1)° C. 100 calibrated chippings are spread on the binder and then rolled flat. The plate prepared in this manner is turned over and then placed on a three-point support. A steel ball falls on the plate from a height of 500 mm, three times in 10 s.
Homogeneity by sieving: This is a method for determining the quantity of large particles of binder present in bitumen emulsions. A known mass of bitumen emulsion is filtered, either through a prepared sieve with an aperture size of 0.500 mm, or through two prepared sieves, one with an aperture size of 0.500 mm and the other with an aperture size of 0.160 mm. The quantity of binder found on each sieve is weighed after washing and drying. (NF EN 1429—August 2013)
Storage stability by sieving: Storage stability is determined by the quantity of binder (bitumen emulsion) retained on the sieve with an aperture size of 0.500 mm after a defined storage period (n days) (NF EN 1429—August 2013).
LASER granulometry: Laser granulometry enables the average size of the bitumen droplets of an emulsion and their distribution to be determined. This method also enables the surface specific area of the bitumen droplets to be measured. (Internal test method) Breaking index: The test consists in determining by weighing the quantity of reference fines (Sikaïsol and/or Forshammer) to be added under stirring at constant speed to the bitumen emulsion in order to break this emulsion (NF EN 13075-1—December 2016)
Settling: This method enables the settling tendency of a bitumen emulsion to be evaluated. The sample is left still for a certain period in a stoppered, graduated test tube, after which time the water contents of the upper and lower layers are determined in accordance with EN 1428 or EN 1431. The settling tendency is calculated using the difference between the two water contents. (NF EN 12847—August 2009)
Adhesive force by a water immersion test according to standard NF EN 13614 A—June 2011: The bitumen emulsion is blended carefully with the selected aggregate under specified conditions. To measure the effect of the water on the binder's adhesion the blend is first cured, and then immersed in water under specified conditions. The surface percentage of aggregate covered with binder is assessed visually under specified conditions.
The compactability of a bituminous concrete with emulsion is determined by the compacting test using the gyratory shear compactor (NF P 98-252—June 1999): Compacting is obtained by kneading under low static compression with a cylinder of hydrocarbon blend contained in a mould limited by discs, kept at a fixed temperature. Compacting is obtained by the combination of gyratory shearing and a resulting axial force applied by a mechanical head. This method enables the change of percentage of voids of the test specimen to be determined according to the number of gyrations.
BBE module (NF EN 12697-26 Appendix C—June 2012): Before measuring the modulus of rigidity, test specimens of bituminous concrete with emulsion are prepared by press compacting at a voids content value equivalent to the voids content measured according to the Duriez test method 2, by removing 2%. The test specimens are then subject to curing at 35° C. and 20% hygrometry for 14 days. The modulus of rigidity is then measured after 14 days by indirect traction on cylindrical test specimens conditioned at 10° C. (IT-CY). The rise time, measured from the start of the loading pulse, which is the time required for the application of the load to change from the initial contact load to the maximum value, must be 124±4 ms.
BBE workability: This test is conducted 4 hours after manufacture of the BBE with a NYNAS workability meter. It consists in measuring the force required by a mobile arm to displace at constant speed approximately 10 kg of asphalt mix contained in a mould designed for this purpose. The workability of the asphalt mix is sufficient if the force is less than approximately 200 Newton.

### Description of the Tested Compounds:

The following compounds were tested:
Compounds of formula (I):

1. Rhodiasolv® DIB. This compound is named “DIB” in the following tables.

2. INNROAD® protect. This compound is named “INNROAD® Protect” in the following tables.

3. DIP as defined by the description, designated “DIP” in the following tables.

4. DIA as defined by the description, referred to as “DIA” in the following tables.
Compounds of formula (II):

1. Rhodiasolv® RPDE. This compound is named “RPDE” in the following tables.

2. Rhodiasolv® IRIS. This compound is named “IRIS” in the following tables.

The physico-chemical properties of these compounds are given in the following table:

TABLE 1

| | | | Flash point | | |
|---|---|---|---|---|---|
| | | Vapour | in closed | Density | Boiling |
| | Mw | pressure | vessel | at 20° C. | range |
| | (g/mole) | (Pa) | (° C.) | (g/cm³) | (° C.) |
| RPDE | 159 | 9.4 | 99 | 1.0915 | 195-216 |
| IRIS | 174 | 6.3 | 98 | 1.055 | 215 |
| DIB | 244 | 0.4 | 134 | 0.959 | 250-285 |
| INNROAD ® | 188 | — | 122 | 1.025 | 210-260 |
| Protect | | | | | |
| DIP | 216 | | | | |
| DIA | 272 | | | | |

### DESCRIPTION OF THE FIGURES

FIG. 1: mass percentage of loss of volatile compound (Rhodiasolv® RPDE (continuous line), Rhodiasolv® DIB (dotted line), INNROAD® Protect (alternating dots and dashes) and Greenflux® SD (discontinuous line—dashes)) as a function of time at 85° C. in the binder of example 1

FIG. 2: mass percentage of loss of volatile compound (Rhodiasolv® RPDE (continuous line), Rhodiasolv® DIB (dotted line) and Greenflux® SD (discontinuous line—dashes)) as a function of time at 85° C. in the binder of example 2

FIG. 3: mass percentage of loss of volatile compound (Rhodiasolv® DIB (dotted line) and Rhodiasolv® IRIS (discontinuous line—dashes/points)) as a function of time at 85° C. in the binder of example 3

### EXAMPLE 1: FLUXED BINDERS FOR SURFACE DRESSINGS

The following binders are prepared:

TABLE 2

| | | T0 | C1 | C2 | L1 | L2 | L3 | L4 |
|---|---|---|---|---|---|---|---|---|
| bitumen | Supplier | ESSO | | | | | | |
| | Grade | 70/100 | | | | | | |
| fluxant | Name | — | Petroleum (1) | RPDE | DIB | INNROAD ® | DIP | DIA |
| | | | | | | Protect | | |
| | Content (% by | 0 | 6.2 | 4.5 | 6.2 | 5 | 6 | 6.5 |
| | weight relative | | | | | | | |
| | to the weight of | | | | | | | |
| | the binder) | | | | | | | |
| Adhesion | Name | — | Impact 9000 (2) | | | | | |
| dope | Content (% by | 0 | 0.3 | 0.3 | 0.3 | 0.3 | 0.3 | 0.3 |
| | weight relative | | | | | | | |
| | to the weight of | | | | | | | |
| | the binder) | | | | | | | |

(1) Greenflux ® SD sold by TOTAL
(2) fatty tallol amides, N-[(dimethylamino)-3propyl] sold by INGEVITY

Binder T0 is a non-fluxed binder, which is used as a control enabling the properties of the binder according to the invention to be compared to the binder without addition of compound according to the invention. Binders C1 and C2 are fluxed binders, which are used as comparative examples. Binders L1 and L2, L3, and L4 are binders according to the invention.

The properties of the binders before/after stabilisation and the results of the adhesiveness of the binders to the aggregates are given in the following table:

TABLE 3

| | T0 | C1 | C2 | L1 | L2 | L3 | L4 |
|---|---|---|---|---|---|---|---|
| | Before stabilisation | | | | | | |
| STV pseudo-viscosity 40° C., 10 mm, s | — | 440 | 484 | 459 | 468 | 483 | 502 |
| Penetrability at 25° C., 1/10 mm | 78 | — | — | — | | — | — |
| Ball-Ring Temperature, ° C. | 46.2 | — | — | — | | — | — |
| | After stabilisation | | | | | | |
| Mass loss after stabilisation | — | 3.0% | 3.9% | 4.9% | 4.4% | — | — |
| Penetrability at 25° C., 1/10 mm | — | 124 | 62 | 92 | 66 | — | — |
| Ball-Ring Temperature, ° C. | — | 43.0 | 51.0 | 45.4 | 47.6 | — | — |
| Adhesiveness to the Vialit plate 5° C. + viadop PX10051 40 g/m² | | | | | | | |
| Aggregates 6/10 La Meilleraie - washed and dried | | | | | | | |
| Fallen and not marked | — | 7 | 8 | 5 | 0 | — | — |
| Fallen and marked | — | 39 | 90 | 42 | 50 | — | — |
| Bonded to the plate | — | 54 | 2 | 53 | 50 | — | — |

Stabilisation of the fluxed bitumens is accomplished according to the protocol described in standard NF EN 13074 1.2 (April 2011). All the tests are conducted according to the protocol described in the standards cited in reference, and explained above.

It is observed that the binders according to the invention enable satisfactory results to be obtained in terms of adhesiveness and fluxing (observed through the viscosity).

In addition, the binders according to the invention recover their properties before fluxing, observed through penetrability and the ball-ring temperature.

These results show that the binders according to the invention enable hard surface dressings to be obtained in a short time, allowing fast re-opening to traffic.

As a comparison, it should be noted that Rhodiasolv® RPDE, which does not satisfy formula (I), although it is a volatile compound, does not enable satisfactory adhesiveness to be obtained. Indeed, only 2% of the aggregates remain bonded to the plate. Binder C2 does not have a consistency enabling it to wet the aggregates satisfactorily.

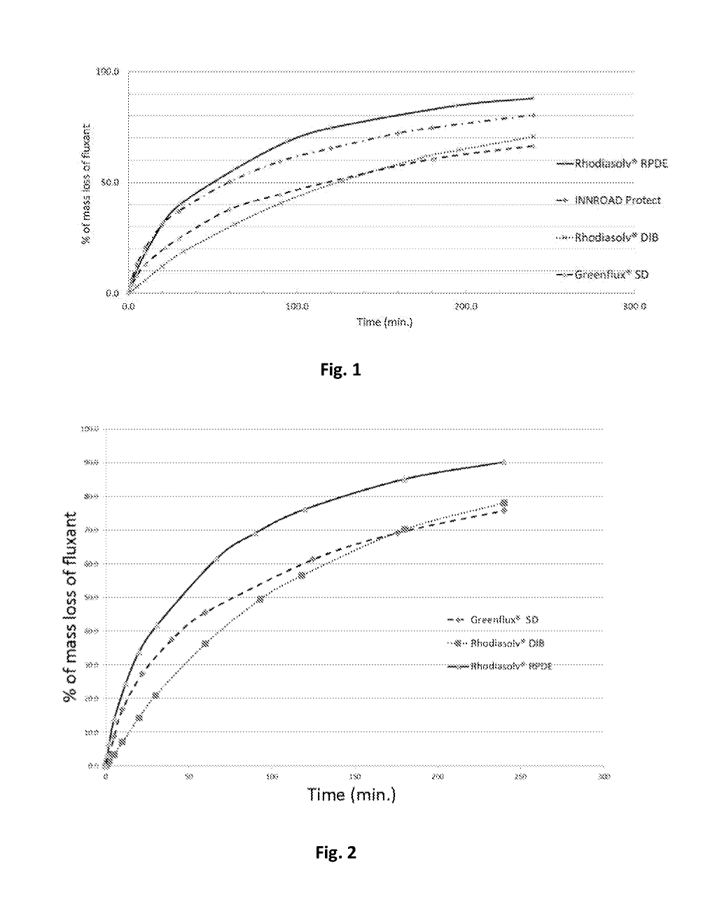

The evaporation curves (mass loss of fluxant as a function of time) for binders C1, C2, L1 and L2 without stabilisation are reproduced in FIG. 1. It is observed that the evaporation kinetics of binders C1 and L1 are similar, whereas in binder C2 the fluxant has evaporated very rapidly. Binder L2 has an evaporation profile which is intermediate between those of binders C1 and C2.

### EXAMPLE 2: FLUXED POLYMER BINDERS FOR SURFACE DRESSINGS

The following binders are prepared:

TABLE 4

| | | C3 | C4 | L5 |
|---|---|---|---|---|
| Polymer | Supplier | Eurovia (1) | | |
| bitumen | Grade | 50/70 bitumen including 3% by | | |
| | | weight, relative to the total | | |
| | | weight, of linear SBS polymer, | | |
| | | cross-linked by sulphur | | |
| fluxant | Name | Petroleum | RPDE | DIB |
| | | (2) | | |
| | Content (% by weight | 15.0 | 12.0 | 13.5 |
| | relative to the | | | |
| | weight of the binder) | | | |
| Adhesion | Name | Impact 9000 (3) | | |
| dope | Content (% by weight | 0.3 | 0.3 | 0.3 |
| | relative to the | | | |
| | weight of the binder) | | | |

(1) this binder has a cohesion greater than or equal to 1.3 J/cm², as measured according to standard NF EN 13588 of July 2008 after stabilisation according to standards NF EN 13074-1 and 13074-2
(2) Greenflux ® SD sold by TOTAL
(3) fatty tallol amides, N-[(dimethylamino)-3propyl] sold by INGEVITY

Binders C3 and C4 are fluxed polymer binders, which are used as comparative examples. Binder L5 is a binder according to the invention.

The properties of the binders before/after stabilisation are given in the following table:

TABLE 5

| | | | | Specifications |
|---|---|---|---|---|
| | | | | (EN 15332, |
| | C3 | C4 | L6 | August 2013) |
| | Before stabilisation | | | |
| STV pseudo-viscosity | 83 | 82 | 84 | |
| 50° C., 10 mm, s | | | | |
| | After stabilisation | | | |
| Mass loss after stabilisation | 11.0% | 11.1% | 10.2% | |
| Penetrability at | 114 | 46 | 119 | ≤120 |
| 25° C., 1/10 mm | | | | |
| Ball-Ring Temperature, | 51.2 | 60.8 | 49.5 | ≥49 |
| ° C. | | | | |
| FRAASS brittle point, ° C. | — | — | −18 | ≤−15 |

Stabilisation of the fluxed bitumens is accomplished according to the protocol described in standard NF EN 13074 1.2 (April 2011). All the tests are conducted according to the protocol described in the standards cited in reference, and explained above.

It is observed that even for highly modified binders the evaporation of the fluxant is suitable, and enables stabilised binders satisfying the specifications according to standard EN 15322 of August 2013 to be obtained.

The evaporation curves (mass loss of fluxant as a function of time) for binders C3, C4, and L3 without stabilisation are reproduced in FIG. 2. It is observed that the evaporation kinetics of binders C3 and L3 are similar whereas in binder C4 the fluxant has evaporated very rapidly.

### EXAMPLE 3: FLUXED POLYMER BINDERS FOR SURFACE DRESSINGS

The following binders are prepared:

TABLE 6

| | | C5 | L6 |
|---|---|---|---|
| bitumen | Supplier | Eurovia (1) | |
| | Grade | 70/100 bitumen including 3% by | |
| | | weight, relative to the total | |
| | | weight, of linear SBS polymer, | |
| | | cross-linked by sulphur | |
| fluxant | Name | IRIS | DIB |
| | Content (% by weight | 7.0 | 8.02 |
| | relative to the | | |
| | weight of the binder) | | |
| Adhesion | Name | Impact 9000 (1) | |
| dope | Content (% by weight | 0.3 | 0.3 |
| | relative to the | | |
| | weight of the binder) | | |

(1) this binder has a cohesion greater than or equal to 1 J/cm², as measured according to standard NF EN 13588 of July 2008 after stabilisation according to standards NF EN 13074-1 and 13074-2
(2) fatty tallol amides, N-[(dimethylamino)-3propyl] sold by INGEVITY

Binder C5 is a fluxed polymer binder which is used as a comparative example. Binder L6 is a binder according to the invention.

The properties of the binders before/after stabilisations and the results of the binders' adhesiveness to the aggregates are given in the following tale:

TABLE 7

| | | | Specifications |
|---|---|---|---|
| | | | EN 15322, |
| | C5 | L6 | August 2013 |
| | Before stabilisation | | |
| STV pseudo-viscosity | 379 | 367 | 250-500 |
| 40° C., 10 mm, s | | | |
| | After stabilisation | | |
| Mass loss after stabilisation | 5.8% | 5.9% | |
| Penetrability at | 62 | 84 | ≤150 |
| 25° C., 1/10 mm | | | |
| Ball-Ring Temperature, | 50.4 | 48.4 | ≥43 |
| ° C. | | | |
| FRAASS brittle point, ° C. | −13 | −15 | ≤−14 |
| | | | (specific |
| | | | specifications) |
| Adhesiveness to the Vialit plate 5° C. + viadop | | | |
| PX10051 40 g/m² | | | |
| 6/10 ESCHAU aggregates - washed and dried | | | |
| Fallen and not marked | 63 | 11 | |
| Fallen and marked | 37 | 20 | |
| Bonded to the plate | 0 | 69 | |

Stabilisation of the fluxed bitumens is accomplished according to the protocol described in standard NF EN 13074 1.2 (April 2011). All the tests are conducted according to the protocol described in the standards cited in reference, and explained above.

It is observed that the binder according to the invention enables satisfactory results to be obtained in terms of adhesiveness and fluxing (observed through the viscosity). In addition the binder according to the invention has penetrability, ball-ring temperature and FRAASS brittle point properties in accordance with the specifications. These results show that the binder modified according to the invention enables hard surface dressings to be obtained in short times, allowing fast re-opening to traffic.

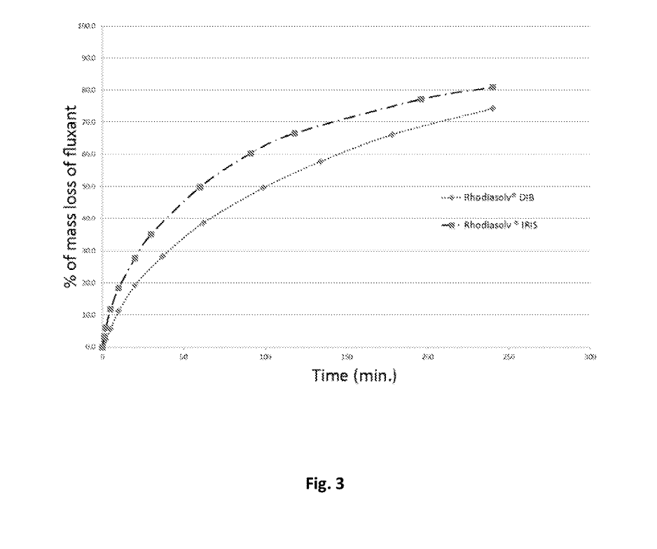

As comparison, it should be noted that Rhodiasolv® IRIS, which does not satisfy formula (I), although this is a volatile compound, does not enable satisfactory adhesiveness to be obtained. Indeed, no aggregates remain bonded to the plate and 63% of the aggregates fall without being marked. Binder C5 does not have a consistency enabling it to wet the aggregates satisfactorily. However, if the evaporation curves are compared for C5 and L6, the IRIS and DIB compounds have similar properties (FIG. 3). These results show that the evaporation curve of the compounds in the bitumen is not the only parameter enabling a fluxant to be chosen which allows the goals of the invention to be attained.

### EXAMPLE 4: EMULSIFIED FLUXED POLYMER BINDERS FOR SURFACE DRESSINGS

The following binders are prepared:

TABLE 8

| | | C6 | L7 | L8 |
|---|---|---|---|---|
| Polymer | Supplier | Eurovia (1) | | |
| bitumen | Grade | 70/100 bitumen including 2.6% by | | |
| | | weight, relative to the total | | |
| | | weight, of linear SBS polymer, | | |
| | | cross-linked by sulphur | | |
| fluxant | Name | Petroleum | DIB | Innroad ® |
| | | (2) | | Protect |
| | Content (% by weight | 5.4 | 5.4 | 5.4 |
| | relative to the | | | |
| | weight of the binder) | | | |

(1) this binder has a cohesion greater than or equal to 1.3 J/cm², as measured according to standard NF EN 13588 of July 2008 after stabilisation according to standards NF EN 13074-1 and 13074-2
(2) Greenflux ® SD sold by TOTAL

Binder C5 is a fluxed polymer binder which is used as a comparative example. Binders L7 and L8 are binders according to the invention.

The properties of the binders before stabilisation are given in the following table:

TABLE 9

| | | |
|---|---|---|
| C6 | L7 | L8 |

dynamic viscosity, mPa · s (NF EN 13302)

| | | | |
|---|---|---|---|
| 100° C. | 2023 | 1962 | 1470 |
| 120° C. | 641 | 635 | 500 |
| 140° C. | 271 | 219 | 49.5 |
| 160° C. | 135 | 132 | 117 |

Binders L7 and L8 have a viscosity comparable to that of the reference binder, C6.

These binders C6, L7 and L8 were emulsified using the same emulsification method, with the same surfactant (HCl/amine). Cationic emulsions are manufactured.

The properties of the binder emulsions are given in the following table:

TABLE 10

| | | |
|---|---|---|
| Emulsion based | Emulsion based | Emulsion based |
| on C6 | on L8 | on L9 |

Pseudo-viscosity (NF EN 12846-1)

| | | | |
|---|---|---|---|
| STV 40° C., | 13 | 11 | 12 |
| 4 mm, s | | | |
| STV 40° C., | 160 | 117 | 134 |
| 2 mm, s | | | |

Homogeneity by sieving (NF EN 1429)

| | | | |
|---|---|---|---|
| Non-passing at | 0.04 | 0.03 | 0.02 |
| 0.500 mm | | | |
| Non-passing at | 0.28 | 0.19 | 0.18 |
| 0.160 mm | | | |

Storage stability by sieving (NF EN 1429)

| | | | |
|---|---|---|---|
| N (days) | 7 | 7 | 7 |

LASER granulometry (Malvern): MEI

| | | | |
|---|---|---|---|
| Median diameter | 2.98 | 2.86 | 2.70 |
| (μm) | | | |

Dynamic viscosity (NF EN 13302)

| | | | |
|---|---|---|---|
| A 40° C. (mPa · s) | 2 s⁻¹ 6.0% | 2 s⁻¹ 4.4% | 2 s⁻¹ 5.1% |
| | 300 mPa · s | 220 mPa · s | 255 mPa · s |
| | 20.4 s⁻¹ 45.4% | 20.4 s⁻¹ 34.3% | 20.4 s⁻¹ 38.9% |
| | 226 mPa · s | 171 mPa · s | 194 mPa · s |
| | 34 s⁻¹ 69.7% | 34 s⁻¹ 53.2% | 34 s⁻¹ 60.1% |
| | 210 mPa · s | 160 mPa · s | 180 mPa · s |

Breaking index (NF EN 13075-1)

| | | | |
|---|---|---|---|
| Sikaïsol | 47 | 34 | 51 |
| Forshammer | 66 | 48 | 71 |

Settling (NF EN 12847)

| | | | |
|---|---|---|---|
| 7 days, 25° C. | 0.4 | 1.1 | 0.6 |

The properties of the emulsions are compliant with the expected specifications. The properties of the emulsions with binders L7 and L8 are comparable to those observed for the emulsion with binder C6.

For each of these emulsions the adhesiveness was determined by a water immersion test according to standard NF EN 13614 (June 2011) with 6/10 DUSSAC aggregates (200 g washed and dried). The results are given in the following table:

TABLE 11

| | Emulsion | Emulsion | Emulsion |
|---|---|---|---|
| | based on C6 | based on L7 | based on L8 |
| Aggregate | 6/10 DUSSAC washed/dried | | |
| Mineralogical nature | Diorite | | |
| Residual aggregate/binder | 200/10 | 200/10 | 200/10 |
| mass ratio | | | |
| Coating | Good | Good | Good |
| Rating (% of covering) | 90 | 90 | 90 |

A satisfactory coating (90% of surface covered after immersion in water) was obtained with 10 g of residual binder for each of the emulsions.

The emulsions were stabilised according to the protocol described in the introduction. The results are given in the following table:

TABLE 12

| | Emulsion | Emulsion | Emulsion | |
|---|---|---|---|---|
| | based | based | based | |
| | on C6 | on L7 | on L8 | Specifications |
| Penetrability at | 58 | 64 | 41 | <100 |
| 25° C. (1/10 mm) | | | | |
| Ball-ring temper- | 56.8 | 55.2 | 59.8 | ≥50 |
| ature (° C.) | | | | |

The properties of the stabilised emulsions show a slightly lower evaporation of the DIB compared to the petroleum fluxant and a faster evaporation of the Innroad® Protect compared to the petroleum fluxant. The presence of residual DIB is observed in binder L7.

### EXAMPLE 5: BITUMINOUS CONCRETES WITH EMULSION

Bituminous concretes with emulsion are prepared with the following formulae:

TABLE 13

| | BBE I1 | BBE I2 | BBE I3 | BBE C1 | BBE C2 | BBE C3 |
|---|---|---|---|---|---|---|
| Solid | 0/4 Uzerche aggregates | | | | | |
| mineral | 4/6.3 Pagnac | | | | | |
| fraction | 6/10 Pagnac pre-lacquered with 1.8 pph of emulsion | | | | | |
| Added | 7.1 pph | | | | | |
| emulsion | | | | | | |
| Fluxant - | 0.3 pph | | | | | 0 |
| content | | | | | | |
| Fluxant - | DIB | 80/20 | Innroad ® | Oleoflux ® | Greenflux ® | — |
| nature | | blend by | Protect | | SD | |
| | | weight of | | | | |
| | | DIB/RPDE | | | | |
| Theoretical | 5.0 pph | 5.0 pph | 5.0 pph | 5.3 pph | 5.0 pph | 5.0 pph |
| residual | | | | | | |
| anhydrous | | | | | | |
| binder | | | | | | |
| content | | | | | | |

“pph” means “parts per hundred by weight” compared to the weight of the solid mineral fraction.

The pre-lacquering or contributed emulsion is in both cases a cationic emulsion. In both cases bitumen emulsions are used including a 70/100 bitumen as a binder. In both cases bitumen emulsions are used with a binder content of 65% by weight, compared to the total weight of the emulsion.

The fluxant is introduced by spraying at the end of the mixing.

TABLE 14

| | BBE | BBE | BBE | BBE | BBE |
|---|---|---|---|---|---|
| | I4 | I5 | C4 | C5 | C6 |
| Solid | 0/2 Dussac + 2/6 Dussac + | | | | |
| mineral | 6/10 Dussac | | | | |
| fraction | | | | | |
| Added | 7.7 pph | | | | |
| emulsion | | | | | |
| Fluxant - | 0.3 pph | | | | 0 |
| content | | | | | |
| Fluxant - | DIB | INNROAD ® | Oléoflux ® | Greenflux ® | — |
| nature | | Protect | | SD | |
| Theoretical | 5.0 | 5.0 | 5.3 | 5.0 | 5.0 |
| residual | pph | pph | pph | pph | pph |
| anhydrous | | | | | |
| binder | | | | | |
| content | | | | | |

“pph” means “parts per hundred by weight” compared to the weight of the solid mineral fraction.

The pre-lacquering or contributed emulsion is in both cases a cationic emulsion. In both cases bitumen emulsions are used including a 70/100 bitumen as a binder. In both cases bitumen emulsions are used with a binder content of 65% by weight, compared to the total weight of the emulsion.

The fluxant is introduced by spraying at the end of the mixing.

In the case of the Uzerche-Pagnac formulae, the compactability (PCG), the modulus and the workability of these bituminous concretes with emulsion are evaluated. The results for the Uzerche-Pagnac formulae are given in the following tables:

TABLE 15

| | PCG | | | | | | | | | | | | | |
|---|---|---|---|---|---|---|---|---|---|---|---|---|---|---|
| | % of voids as a function of a number of gyrations | | | | | | | | | | | | | |
| | 5 | 10 | 15 | 20 | 25 | 30 | 40 | 50 | 60 | 80 | 100 | 120 | 150 | 200 |
| BBE I1 | 23.3 | 20.0 | 18.2 | 17.0 | 16.1 | 15.3 | 14.2 | 13.4 | 12.7 | 11.7 | 10.9 | 10.3 | 9.5 | 8.6 |
| BBE I2 | 24.9 | 21.7 | 19.9 | 18.7 | 17.8 | 17 | 16 | 15.1 | 14.4 | 13.4 | 12.6 | 12 | 11.2 | 10.3 |
| BBE I3 | 23.9 | 20.7 | 19 | 17.8 | 16.8 | 16.1 | 15 | 14.1 | 13.4 | 12.4 | 11.6 | 11 | 10.3 | 9.4 |
| BBE C1 | 23.7 | 20.5 | 18.6 | 17.4 | 16.5 | 15.8 | 14.6 | 13.7 | 13.0 | 12.0 | 11.2 | 10.6 | 9.8 | 8.8 |
| BBE C2 | 24.1 | 21.2 | 19.1 | 17.9 | 17 | 16.3 | 15.2 | 14.3 | 13.7 | 12.6 | 11.9 | 11.3 | 10.6 | 9.7 |
| BBE C3 | 27.1 | 23.8 | 21.9 | 20.7 | 19.8 | 19.1 | 18 | 17.1 | 16.5 | 15.5 | 14.7 | 14.1 | 13.4 | 12.5 |

The compactability results demonstrate the ability of compound (I), alone or in combination with compounds (II), to improve the compacting of the bituminous concrete with emulsion, and to reduce the void content relative to the same formula without fluxant (BBE C3).

TABLE 16

| | Changes of the Modulus (MPa) | | | | |
|---|---|---|---|---|---|
| | 10° C. 124 ms conservation 35° C. 20% RH | | | | |
| | | | | | % of voids |
| | 3 days | 7 days | 14 days | 21 days | (gamma bench) |
| BBE I1 | 1039 | 1375 | 1402 | 1533 | 15 ± 1 |
| BBE I2 | 1078 | 1337 | 1341 | 1554 | 15 ± 1 |
| BBE I3 | 1185 | 1378 | | 2179 | 15 ± 1 |
| BBE C1 | 252 | 455 | 491 | 578 | 15 ± 1 |
| BBE C2 | 820 | 1109 | 1313 | 1463 | 15 ± 1 |

Compound (I), alone or in combination with compound (II), allows a satisfactory increase of consistency of the bituminous concrete with emulsion compared in particular to reference formula BBE C1. It should be noted in particular that INNROAD® Protect gives the best results.

TABLE 17

| | Workability (N) after 4 |
|---|---|
| | hours |
| BBE I1 | 332 |
| BBE I2 | 247 |
| BBE I3 | 336 |
| BBE C1 | 272 |
| BBE C2 | 233 |
| BBE C3 | 187 |

Compound (I), alone or in combination with compound (II), enables an acceptable workability value to be maintained

In the case of the Dussac formulae, the compactability (PCG) and workability of these bituminous concretes with emulsion are evaluated.

The results for the Dussac formulae are given in the following tables:

TABLE 18

| | PCG | | | | | | | | | | | | | |
|---|---|---|---|---|---|---|---|---|---|---|---|---|---|---|
| | % of voids as a function of the number of gyrations | | | | | | | | | | | | | |
| | 5 | 10 | 15 | 20 | 25 | 30 | 40 | 50 | 60 | 80 | 100 | 120 | 150 | 200 |
| BBE I4 | 27.0 | 24.0 | 22.4 | 21.2 | 20.4 | 19.7 | 18.7 | 18.0 | 17.4 | 16.6 | 15.9 | 15.4 | 14.8 | 14.1 |
| BBE I5 | 26.3 | 23.2 | 21.5 | 20.4 | 19.5 | 18.8 | 17.8 | 17.1 | 16.5 | 15.6 | 15.0 | 14.5 | 13.9 | 13.2 |
| BBE C4 | 25.9 | 22.8 | 21.1 | 20.0 | 19.1 | 18.4 | 17.5 | 16.7 | 16.1 | 15.3 | 14.6 | 14.1 | 13.6 | 12.9 |
| BBE C5 | 26.3 | 23.5 | 21.8 | 20.8 | 19.9 | 19.3 | 18.4 | 17.7 | 17.1 | 16.3 | 15.7 | 15.2 | 14.6 | 14.0 |
| BBE C6 | 27.6 | 24.7 | 23.1 | 21.9 | 21.1 | 20.5 | 19.4 | 18.7 | 18.1 | 17.3 | 16.6 | 16.1 | 15.5 | 14.8 |

The compactability results demonstrate the ability of compound (I) to improve the compacting of the bituminous concrete with emulsion, and to reduce the void content relative to the same formula without fluxant (BBE C6).

TABLE 19

| | Workability (N) after 4 |
|---|---|
| | hours |
| BBE I4 | 344 |
| BBE I5 | 175 |
| BBE C4 | 241 |
| BBE C5 | 406 |
| BBE C6 | 641 |

Compound (I) enables the workability of the bituminous concretes with emulsion to be improved relative to the reference solutions.

### EXAMPLE 6: COLD MIX BITUMINOUS MATERIALS (MBCF)

When a 50/70 bitumen grade is used for the formulation of MBCF, the bitumen should be fluxed slightly at the start and late in season, in order to facilitate the cohesion increase of the MBCF at low temperatures. The table below shows the penetrability and ball-ring temperature variations as a function of the fluxant concentration:

TABLE 20

| | | | 99.5% | 99.2% | | 99% | 98.5% |
|---|---|---|---|---|---|---|---|
| | | | 50/70 + | 50/70 + | 99% 50/70 + | 50/70 + | 50/70 + |
| | | | 0.5% | 0.8% | 1% | 1% | 1.5% |
| | 50/70 | 70/100 | INNROAD ® | INNROAD ® | INNROAD ® | Greenflux | Greenflux |
| | bitumen | bitumen | protect | protect | protect | SD | SD |
| Penetrability | 52 | 80 | 66 | 76 | 83 | 73 | 86 |
| at 25° C. | | | | | | | |
| in 1/10 mm | | | | | | | |
| NF EN 1426 | | | | | | | |
| Ball-Ring | 50.0 | 45.6 | 48.4 | 47.6 | 46.6 | 47.6 | 46.0 |
| temperature, | | | | | | | |
| ° C. | | | | | | | |
| NF EN 1427 | | | | | | | |

The percentages are weight percentages.

Compound (I) enables a change of grade of the bitumen to a lower concentration than the reference fluxant to be guaranteed.

1. Method for preparing a bituminous product based on solid mineral particles in contact with a hydrocarbon binder, comprising a step of contacting a composition with solid mineral particles, said composition including a hydrocarbon binder, wherein at least one compound with the formula (I)
R¹—X—R—Y—R² (I)
where:
R¹ and R², which can be identical or different, are hydrocarbon chains, linear or branched, at C₂-C₁₁;
each of —X— and —Y—, which can be identical or different, is an —O—(C═O)— group; —(C═O)—O—; —NR′—(C═O)—, where R′ represents a hydrocarbon atom or an alkyl radical at C₁-C₄, or —(C═O)—NR′—, where R′ represents a hydrocarbon atom or an alkyl radical at C₁-C₄,
the —R— group is a divalent hydrocarbon chain, at C₁-C₁₀, linear or branched, and possibly interrupted by one or more oxygen atom(s)
is added as a fluxant agent to said composition before, at the same time as or after the step of contacting the composition with the solid mineral particles, said step being achieved before complete evaporation of the compound of formula (I) outside the composition.

2. Method according to claim 1, wherein the compound of formula (I) is added to the composition including the hydrocarbon binder according to one and/or other of the following 3 compatible variants:
i. variant 1: the compound of formula (I) is added at least partly (if variant 2 and/or 3 is also used), or wholly (otherwise), to the composition including the hydrocarbon binder; the composition including the compound of formula (I) is then brought into contact with the solid mineral particles before complete evaporation of the compound of formula (I) outside the composition (in other words the said compound of formula (I) is still present, at least in part, in the composition when it is brought into contact with the solid mineral particles, preferably in a sufficient quantity in the composition for it to act as a fluxant);
and/or
ii. variant 2: the compound of formula (I) is added at least in part (if variant 1 and/or 3 is also used), or wholly (otherwise), at the same time as the solid mineral particles, to the composition including the hydrocarbon binder;
and/or
iii. variant 3: the compound of formula (I) is added at least in part (if variant 1 and/or 2 is also used), or wholly (otherwise), to a pre-blend containing the solid mineral particles, and the composition including the hydrocarbon binder.

3. Method according to claim 1, wherein the composition also includes a compound satisfying formula (II)
R¹—X—R—Y—R² (II)
where:
R¹ and R², which can be identical or different, are hydrocarbon chains, linear or branched, at C₁-C₁₁; and where at least one of R¹, R² is a methyl radical
—X— and —Y—, —R— are as defined for formula (I) in claim 1.

4. Method according claim 1, wherein the bituminous product is a surface dressing.

5. Method according to claim 4, wherein in formula (I):
R¹ and R² are identical, and each is chosen from among the ethyl, n-propyl, isopropyl, n-butyl, isobutyl, n-pentyl, isoamyl, hexyl, n-hexyl, isooctyl, 2-ethylhexyl and 2-propylhexyl groups;
R is a radical of formula —(CH₂)ᵣ—, where r is an average number of between 2 and 4 inclusive.

6. Method according to claim 1, wherein that the bituminous product is a bituminous concrete with emulsion.

7. Method according to claim 6, wherein in formula (I):
R¹ and R² are identical, and each is chosen from among the ethyl, n-propyl, isopropyl, n-butyl, isobutyl, n-pentyl, isoamyl, hexyl, n-hexyl, isooctyl, 2-ethylhexyl and 2-propylhexyl groups;
R is a radical of formula —(CH₂)ᵣ—, where r is an average number of between 2 and 4 inclusive.

8. Method according to claim 6, wherein the composition also includes a compound of formula (II).

9. Method according to claim 7, wherein the composition also includes a compound of formula (II).

10. Method according to claim 6, wherein the hydrocarbon binder includes 1 to 25% by weight of the said compound of formula (I), relative to the total weight of the hydrocarbon binder and, if applicable, 0.1 to 5% by weight of the said compound of formula (II), relative to the total weight of the hydrocarbon binder.

11. Method according to claim 1, wherein the bituminous product is a hot mix or warm mix.

12. Method according to claim 11, wherein in formula (I)
R¹ and R² are identical, and each is chosen from among the ethyl, n-propyl, isopropyl, n-butyl, isobutyl, n-pentyl, isoamyl, hexyl, n-hexyl, isooctyl, 2-ethylhexyl and 2-propylhexyl groups;
R is a radical of formula —(CH₂)ᵣ—, where r is an average number of between 2 and 4 inclusive.

13. Method according to claim 11, wherein the hydrocarbon binder includes 1 to 30% by weight of the said compound of formula (I), compared to the total weight of the hydrocarbon binder.

14. Method according to claim 1, wherein the bituminous product is a storable asphalt mix.

15. Method according to claim 1, wherein the bituminous product is a cold mix bituminous material.

16. Method according to claim 5, wherein in formula (I), X and Y are esters of diacids (—X—=—O—(C═O)—; and —Y—=—(C═O)—O—) or esters of diols (—X—=—(C═O)—O— and —Y—=—O—(C═O)—).

17. Method according to claim 7, wherein in formula (I), X and Y are esters of diacids (—X—=—O—(C═O)—; and —Y—=—(C═O)—O—) or esters of diols (—X—=—(C═O)—O— and —Y—=—O—(C═O)—).

18. Method according to claim 8, wherein in a compound of formula (II):
R¹ and R² are identical and are each methyl;
R is a radical of formula —(CH₂)ᵣ—, where r is an average number of between 2 and 4 inclusive.

19. Method according to claim 18, wherein in formula (II), X and Y are esters of diacids (—X—=—O—(C═O)—; and —Y—=—(C═O)—O—) or esters of diols (—X—=—(C═O)—O— and —Y—=—O—(C═O)—).

20. Method according to claim 9, wherein in a compound of formula (II):
R¹ and R² are identical and are each methyl;
group R is chosen from among the following groups: group R_{MG} of formula —CH(CH₃)—CH₂—CH₂—, group R_{ES} of formula —CH(C₂H₅)—CH₂—, and their blends.

21. Method according to claim 20, wherein in formula (II), X and Y are esters of diacids (—X—=—O—(C═O)—; and —Y—=—(C═O)—O—) or esters of diols (—X—=—(C═O)—O— and —Y—=—O—(C═O)—).

22. Method according to claim 12, wherein in formula (II), X and Y are esters of diacids (—X—=—O—(C═O)—; and —Y—=—(C═O)—O—) or esters of diols (—X—=—(C═O)—O— and —Y—=—O—(C═O)—).
